(19) United States
(12) Patent Application Publication
(10) Pub. No.: US 2018/0054573 A1
(43) Pub. Date: Feb. 22, 2018

(54) ISOTHERMAL IMAGE ENHANCEMENT SYSTEMS AND METHODS

(71) Applicant: FLIR Systems, Inc., Wilsonville, OR (US)

(72) Inventor: Charles W. Handley, Santa Barbara, CA (US)

(21) Appl. No.: 15/786,428

(22) Filed: Oct. 17, 2017

Related U.S. Application Data
(63) Continuation of application No. PCT/US2016/031369, filed on May 6, 2016.
(60) Provisional application No. 62/159,150, filed on May 8, 2015.

(51) Int. Cl. H04N 5/265; H04N 5/33; H04N 7/18; B60R 1/00

(52) U.S. Cl. CPC H04N 5/265; H04N 5/33; G06T 5/50; B60R 1/00; H04N 7/183

(57) ABSTRACT

Systems and methods are provided for generating isothermally enhanced images. An isothermally enhanced image may be an isothermally enhanced non-thermal image such as an isothermally enhanced visible light image. An isothermally enhanced visible light image may include a visible light image portion and a thermal image portion. The thermal image portion may be a portion of the image having temperature-related pixel values. The portion of the image may correspond to an image of an object or objects having temperatures within a particular temperature range. In this way, an isothermally enhanced visible light image may be provided that has visible light image resolution for scene and object identification and recognition and has temperature information for objects having temperatures of interest such as particularly hot objects or particularly cold objects. The temperature information in may be presented using colors each corresponding to isothermal portions of the image.

### CROSS-REFERENCE TO RELATED APPLICATIONS

This application is a continuation of International Patent Application No. PCT/US2016/031369 filed May 6, 2016 and entitled “ISOTHERMAL IMAGE ENHANCEMENT SYSTEMS AND METHODS,” which is incorporated herein by reference in its entirety.

International Patent Application No. PCT/US2016/031369 filed May 6, 2016 claims priority to and the benefit of U.S. Provisional Patent Application No. 62/159,150 filed May 8, 2015 and entitled “ISOTHERMAL IMAGE ENHANCEMENT SYSTEMS AND METHODS,” which is incorporated herein by reference in its entirety.

### TECHNICAL FIELD

One or more embodiments of the present invention relate generally to infrared cameras and, more particularly, to image processing systems and methods for infrared cameras.

### BACKGROUND

Thermal infrared cameras capture thermal images and provide an output image or a video stream to a user. In some systems, captured thermal images are sometimes blended or overlaid onto additional images produced by a non-thermal imager such as an image intensifier. In some systems, high contrast portions of a visible image can be overlaid on a thermal image to help distinguish the objects in the thermal image. However, if care is not taken, it can be difficult to provide a viewer of an image with both thermal information and visible information where each is simultaneously beneficial to a viewer. As a result, there is a need for improved techniques for infrared image processing.

### SUMMARY

Systems and methods are disclosed, in accordance with one or more embodiments, which are directed to isothermal image enhancement processes such as for dual band cameras. In an embodiment, one or more visible light images such as an analog video image from a visible color camera may be captured, digitized, and combined with an isothermal image generated, for example, by an infrared camera such as an uncooled bolometer camera to form an isothermally enhanced visible image. Isothermal enhancing operations may include two main processes, an isothermal image generation process, and a blending process. In the isothermal image blending process, an isothermal image may be provided by the infrared camera in which color pixels represent pixels within a defined temperature range and greyscale pixels represent pixel values outside of that range. In the blending process, a visible color image may be combined with the isothermal color/greyscale image such that, wherever the isothermal image has color pixels, spatially corresponding visible image pixels are replaced with the color isothermal pixels. In this way, hot objects in an image may be shown using isothermal pixels that indicate the temperature of each hot object while remaining portions of the image are shown in full visible color. For example, an image of the view of a racecar driver may be provided to the driver or a team member showing the tires on the racecar with a color highlight representing a temperature range of the tires while still allowing full visual understanding of the view of the racetrack which is essential for driving operations.

In accordance with an embodiment, an imaging system is provided that includes a thermal imaging component configured to capture a thermal image; a non-thermal imaging component configured to capture a non-thermal image; a memory that stores at least one temperature range; and processing circuitry configured to: generate an isothermal image based on the thermal image and the at least one temperature range; and combine the isothermal image with the non-thermal image to form an isothermally enhanced non-thermal image.

In accordance with another embodiment, a method is provided that includes capturing a thermal image; capturing a non-thermal image; generating an isothermal image based on the thermal image and at least one temperature range; and combining the isothermal image with the non-thermal image to form an isothermally enhanced non-thermal image.

The scope of the invention is defined by the claims, which are incorporated into this Summary by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a block diagram illustrating an imaging system in accordance with one or more embodiments.

FIG. 2 shows an illustrative example of an isothermally enhanced visible light image in accordance with one or more embodiments.

FIG. 3 shows a flow chart illustrating a method of generating an isothermally enhanced visible light image in accordance with an embodiment.

FIG. 4 shows a flow chart illustrating a method of generating an isothermal infrared image in accordance with an embodiment.

FIG. 5 shows a flow chart illustrating a method of combining an isothermal infrared image with a visible light image in accordance with an embodiment.

Embodiments of the invention and their advantages are best understood by referring to the detailed description that follows. It should be appreciated that like reference numerals are used to identify like elements illustrated in one or more of the figures.

### DETAILED DESCRIPTION

Systems and methods are disclosed herein to provide, according to various embodiments, enhanced detection and display of objects of interest in images. For example, a camera may include an infrared image capture component such as a thermal image capture component and/or a non-thermal image capture component such as a visible and/or near infrared (VIS/NIR) image capture component. Thermal images may be captured using the thermal image capture component. Non-thermal images may be captured using the non-thermal image capture component.

An isothermal masking process may be performed for the thermal images that generates an isothermal image in which pixels of the isothermal image have values according to particular temperature ranges. For example, all pixels with values corresponding to a temperature range between A degrees and B degrees may have a blue color value and all pixels with values corresponding to a temperature range between C degrees and D degrees may have a red color value. In this way, the coloring of the isothermal image may indicate isotherms in the imaged scene.

In an embodiment, only isothermal image pixels having temperature values in a particular temperature range may be isothermally colored and pixels outside the temperature range may have greyscale values. The temperature range may be a predetermined range or a programmable (e.g., user programmable) temperature range. The isothermal image may be combined with a non-thermal image such as a visible light image. In this way, a user may be provided with the ability to highlight, in an otherwise visible light image, objects of various temperature ranges.

In some embodiments, the color(s) used for the temperature range of interest may also be configured by the user. Combining the visible light and isothermal image may include generating a thermal mask in which pixels corresponding to color pixels in the isothermal image are provided with a first value (e.g., an unmasked value such as 1) and pixels corresponding to greyscale pixels in the isothermal image are provided with a second value (e.g., a masked value such as 0) to identify one or more portions of thermal image that are in the temperature range of interest. This newly defined thermal mask may then be used to control the blending of a thermal with a visible image.

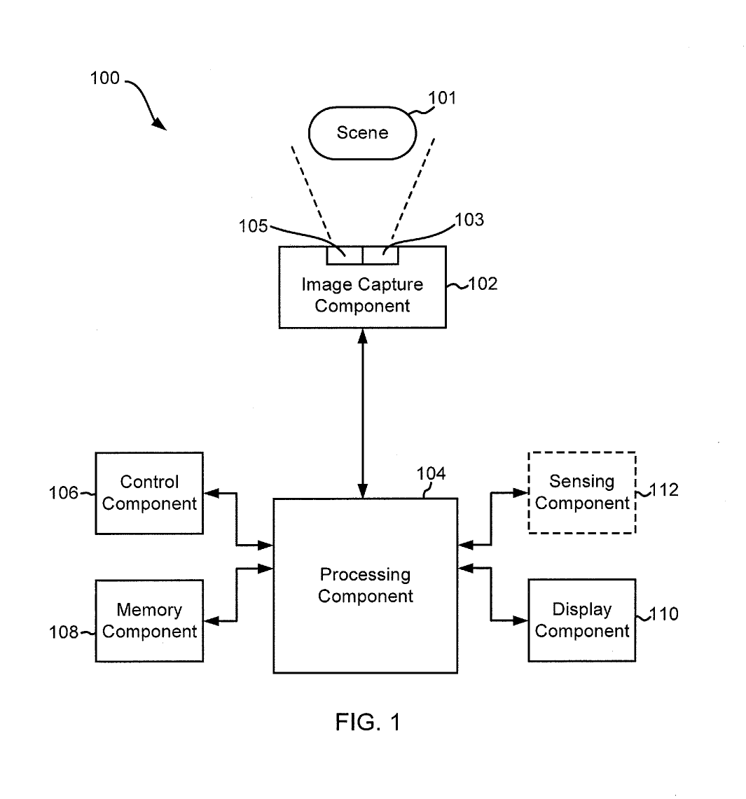

As an implementation example, FIG. 1 shows a block diagram illustrating a system 100 for capturing and processing images, in accordance with one or more embodiments. System 100 includes, in one implementation, an image capture component 102, a processing component 104, a control component 106, a memory component 108, and a display component 110. Optionally, system 100 may include a sensing component 112.

System 100 may represent, for example, a combined thermal and non-thermal imaging device. Image capture component 102 may include a thermal imaging device, such as an infrared camera, to capture and process thermal images, such as thermal video images of a scene 101 and a non-thermal imaging device such as an visible and/or near-infrared camera (e.g., a charge-coupled-device (CCD) or complementary metal oxide semiconductor (CMOS) device), to capture and process non-thermal images, such as visible light and/or NIR video images of scene 101.

System 100 may include a portable device and/or may be incorporated, for example, into another system such as a vehicle (e.g., an automobile or other type of land-based vehicle such as a racecar, an aircraft, or a spacecraft), a wearable device such as a helmet camera system or weapon sight system, a handheld device, or a non-mobile installation in which images are be stored and/or displayed or may comprise a distributed networked system (e.g., processing component 104 distant from and controlling image capture component 102 via the network).

In various embodiments, processing component 104 may comprise any type of a processor or a logic device, such as a programmable logic device (PLD) configured to perform processing functions. Processing component 104 may be adapted to interface and communicate with components 102, 106, 108, and 110 to perform method and processing steps and/or operations, such as controlling biasing and other functions (e.g., values for elements such as variable resistors and current sources, switch settings for biasing and timing, and other parameters) along with other conventional system processing functions as would be understood by one skilled in the art.

Memory component 108 includes, in one embodiment, one or more memory devices adapted to store data and information, including, for example, infrared data and information. Memory device 108 may include one or more various types of memory devices including volatile and non-volatile memory devices, including computer-readable medium (portable or fixed). Processing component 104 may be adapted to execute software stored in memory component 108 so as to perform method and process steps and/or operations described herein. Memory component may store one or more threshold values such as thermal threshold values and/or edge threshold values.

Image capture component 102 includes, in one embodiment, thermal image capture component 103 (e.g., any type of multi-pixel infrared detector such as a focal plane array (FPA)) for capturing infrared image data (e.g., still image data and/or video data) representative of an image, such as scene 101. Thermal image capture component 103 may include an array of infrared sensors responsive to infrared radiation (e.g., thermal energy) from a target scene including, for example, mid wave infrared wave bands (MWIR), long wave infrared wave bands (LWIR), and/or other thermal imaging bands as may be desired in particular implementations. In one embodiment, thermal image capture component may be provided in accordance with wafer level packaging techniques.

Infrared sensors (not shown) in component 103 may be implemented, for example, as microbolometers or other types of thermal imaging infrared sensors arranged in any desired array pattern to provide a plurality of pixels. In one embodiment, infrared sensors may be implemented as vanadium oxide (VOx) detectors. In various embodiments, arrays of approximately 32 by 32 infrared sensors, approximately 64 by 64 infrared sensors, approximately 80 by 64 infrared sensors, 128 by 128 infrared sensors, 256 by 256 infrared sensors, 512 by 512 infrared sensors, 1024 by 1024 infrared sensors, or other array sizes having tens, hundreds, thousands, millions or more sensors may be used.

In one implementation, the thermal image capture component 103 of image capture component 102 includes image processing circuitry such as an analog-to-digital converter that converts signals generated by image sensing elements of component 103 into digital image data.

In one or more embodiments, image capture component 102 may further represent or include a lens, a shutter, and/or other associated components along with, for example, a vacuum package assembly for capturing infrared image data. Image capture component 102 may further include temperature sensors (or temperature sensors may be distributed within system 100) to provide temperature information to processing component 104 as to an operating temperature of image capture component 102.

Image capture component 102 may include one or more additional imaging sensors 105 such as a visible light image sensor (e.g., a charge-coupled device sensor and/or a complementary metal oxide semiconductor sensor), a short-wave infrared sensor, a mid-wave infrared sensor, and/or a low-light visible and/or near infrared (VIS/NIR) sensor such as an image intensifier or an electron multiplying charge coupled device (EMCCD) or other non-thermal image capture component.

Thermal imager 103 may be configured to capture, process, and/or otherwise manage thermal images of scene 101. The thermal images captured, processed, and/or otherwise managed by thermal imager 103 may be radiometrically normalized images. That is, pixels that make up the captured image may contain calibrated thermal data (e.g., temperature data). Thermal imager 103 and/or associated components may be calibrated using appropriate techniques so that images captured by thermal imager 103 are properly calibrated thermal images. In some embodiments, appropriate calibration processes may be performed periodically by thermal imager 103 and/or processor 104 so that thermal imager 103, and hence the thermal images captured by it, may maintain proper calibration.

Radiometric normalization permits thermal imager 103 and/or processor 104 to efficiently detect, from thermal images, objects having a specific range of temperature. Thermal imager 103 and/or processor 104 may detect such objects efficiently and effectively, because thermal images of objects having a specific temperature may be easily discernible from a background and other objects, and yet less susceptible to lighting conditions or obscuring.

In various embodiments, thermal imager 103 may include one or more optical elements (e.g., infrared-transmissive lenses, infrared-transmissive prisms, infrared-reflective mirrors, infrared fiber optics, and/or other elements) for suitably collecting and routing infrared light from scene 101 to an FPA of thermal imager 103. The optical elements may also define an FOV of thermal imager 103.

In one aspect, the infrared image data (e.g., infrared video data) may comprise non-uniform data (e.g., real image data) of an image, such as scene 101. Processing component 104 may be adapted to process the infrared image data (e.g., to provide processed image data), to perform non-uniformity corrections, perform other noise corrections, generate edge images from the processed infrared data, store the infrared image data and/or edge images in memory component 108, and/or retrieve stored infrared image data, edge data, threshold data, or other data from memory component 108. For example, processing component 104 may be adapted to process infrared image data stored in memory component 108 to provide processed image data and information (e.g., captured and/or processed infrared image data).

Processing component 104 may be adapted to perform an isothermal imaging and masking operation that can be used to generate isothermally enhanced images. Performing an isothermal imaging operation may include selecting a portion of a thermal image based on a comparison of the thermal image or isothermal image to one or more thresholds (e.g., one or more temperature and/or intensity thresholds or ranges). The ranges (e.g., the thresholds) can be determined automatically and/or specified by a user.

For example, in one embodiment, a user of system 100 may be provided with the ability to specify one or more temperature thresholds such as a high temperature threshold and a low temperature threshold that define a temperature range. Image data corresponding only to corresponding portions of a scene having temperatures above the low temperature threshold and below the high temperature threshold may then be selected to be represented by isothermal colors in the isothermal image in the isothermal imaging operation.

The isothermal imaging operation may include assigning a color value to thermal image pixels within the selected portion based on the temperature associated with that pixel value. The isothermal imaging operation may include assigning a greyscale value to thermal image pixels outside the selected portion and based on the amount of light received by that pixel. Because the amount of light received by a thermal imaging pixel element is dependent on the temperature of the object being imaged by that pixel, both the color values and the greyscale values in the isothermal image may indicate the temperature of the object being imaged. However, in the color region of the isothermal image, the pixel values may be binned into color bins, each color bin corresponding to a sub-range of temperatures within the overall temperature range of the color portion of the image. In this way, sub-portions of the color portion of the image having a common sub-temperature range can be represented by the same color to indicate isothermal regions of the imaged objects (e.g., regions of the objects having the same or similar temperatures).

Performing an isothermal masking operation may include generating a mask image having pixels that each correspond spatially with a pixel in the isothermal image and assigning a masked value to the pixels in the mask image that spatially correspond to the greyscale pixels of the thermal image and assigning an unmasked value to the pixels in the mask image that spatially correspond to the color pixels of the thermal image.

Processor 104 may be configured to convert thermal image data to user viewable images using appropriate methods and algorithms. In one embodiment, the radiometric data (e.g., temperature data) contained in the pixels of the thermal images may be converted into gray-scaled or color-scaled pixels to construct images that can be viewed by a person for selection of a temperature range for isothermal imaging and masking. User-viewable thermal images may optionally include a legend or scale that indicates the approximate temperature of corresponding pixel color and/or intensity. In another embodiment, processor 104 may be configured to blend, superimpose, fuse, or otherwise combine isothermal images with visible/NIR light images (e.g., captured by visible/NIR light camera 105) to generate user-viewable isothermally enhanced visible light images.

Control component 106 comprises, in one embodiment, a user input and/or interface device, such as a rotatable knob (e.g., potentiometer), push buttons, slide bar, keyboard, etc., that is adapted to generate a user input control signal. Processing component 104 may be adapted to sense control input signals from a user via control component 106 and respond to any sensed control input signals received therefrom. Processing component 104 may be adapted to interpret such a control input signal as a parameter value, as generally understood by one skilled in the art. In one embodiment, control component 106 may comprise a control unit (e.g., a wired or wireless handheld control unit) having push buttons adapted to interface with a user and receive user input control values. In one implementation, the push buttons of the control unit may be used to control various functions of the system 100, such as autofocus, menu enable and selection, field of view, brightness, contrast, noise filtering, high pass filtering, low pass filtering, temperature thresholding, edge thresholding, and/or various other features as understood by one skilled in the art.

Display component 110 comprises, in one embodiment, an image display device (e.g., a liquid crystal display (LCD) or various other types of generally known video displays or monitors). Processing component 104 may be adapted to display image data and information on the display component 110. Processing component 104 may be adapted to retrieve image data and information from memory component 108 and display any retrieved image data and information on display component 110. Display component 110 may comprise display electronics, which may be utilized by processing component 104 to display image data and information (e.g., edge-only infrared images and/or edge-enhanced images). Display component 110 may be adapted to receive image data and information directly from image capture component 102 via the processing component 104, or the image data and information may be transferred from memory component 108 via processing component 104.

Optional sensing component 112 comprises, in one embodiment, one or more sensors of various types, depending on the application or implementation requirements, as would be understood by one skilled in the art. The sensors of optional sensing component 112 provide data and/or information to at least processing component 104. In one aspect, processing component 104 may be adapted to communicate with sensing component 112 (e.g., by receiving sensor information from sensing component 112) and with image capture component 102 (e.g., by receiving data and information from image capture component 102 and providing and/or receiving command, control, and/or other information to and/or from one or more other components of system 100).

In various implementations, sensing component 112 may provide information regarding environmental conditions, such as outside temperature, lighting conditions (e.g., day, night, dusk, and/or dawn), humidity level, specific weather conditions (e.g., sun, rain, and/or snow), distance (e.g., laser rangefinder), and/or whether a tunnel or other type of enclosure has been entered or exited. Sensing component 112 may represent conventional sensors as generally known by one skilled in the art for monitoring various conditions (e.g., environmental conditions) that may have an effect (e.g., on the image appearance) on the data provided by image capture component 102.

In various embodiments, components of system 100 may be combined and/or implemented or not, as desired or depending on the application or requirements, with system 100 representing various functional blocks of a related system. In one example, processing component 104 may be combined with memory component 108, image capture component 102, display component 110, and/or optional sensing component 112. In another example, processing component 104 may be combined with image capture component 102 with only certain functions of processing component 104 performed by circuitry (e.g., a processor, a microprocessor, a logic device, a microcontroller, etc.) within image capture component 102. Furthermore, various components of system 100 may be remote from each other (e.g., image capture component 102 may comprise a remote sensor with processing component 104, etc. representing a computer that may or may not be in communication with image capture component 102).

In many cases, objects of interest (e.g., human beings, animals, vehicles, vehicle parts or components, electrical equipment, or other objects) have surface temperatures that fall within a fairly narrow and specific temperature range. For example, a clothed person may have surface temperatures between, for example, 75° F. (e.g., for a clothed part of a body depending on the ambient temperatures) and approximately 110° F. (e.g., typically around 90° F. for an exposed part of a body such as a face and hands depending on the ambient temperature, person's health, sun exposure, and other known factors as would be understood by one skilled in the art). As another example, racecar tires may heat up during racing operations to between 150 degrees and 250 degrees Fahrenheit due to friction with the road and other forces on the tires. Temperature gradients can also develop across the tire due to uneven forces during, for example, cornering. Temperatures above, for example 200 degrees Fahrenheit or temperature gradients greater than, for example, 20 degrees across the tire can be dangerous and can lead to tire failure if care is not taken.

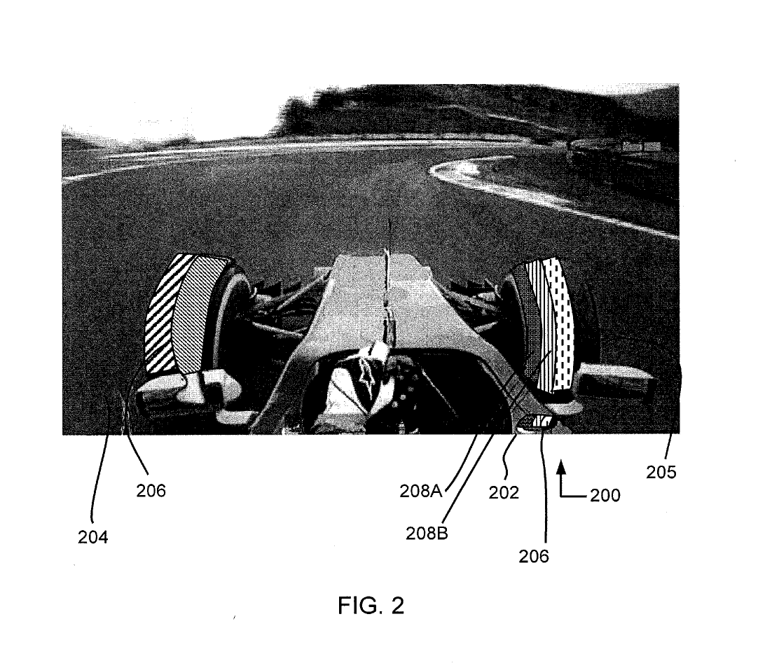

System 100 may be arranged, in one embodiment, to capture images of a portion of a racecar such that one or more tires of the racecar are in the field of view of a thermal and a visible image capture component. Isothermally enhanced visual images of the portion of the racecar may be generated that allow the driver or a crew member to monitor the temperature and gradient of the tires and adjust tire pressures or warn the driver when dangerous conditions arise. FIG. 2 shows an example of an isothermally enhanced visible light image.

As shown in FIG. 2, isothermally enhanced visible light image 200 of an object 202 (e.g., a racecar in which an imaging system such as system 100 is implemented such that components 103 and 105 have a common or overlapping field of view that includes one or more wheels of the racecar) may include a visible light portion 204 and one or more thermal image portions 206. In the example of FIG. 2, the tires 205 of the racecar 202 are hotter than other portions of the racecar and other portions of the background scene and thus are represented by isothermal color pixel values in the isothermally enhanced image 200 that indicate the temperature of various regions of the tires. A system such as system 100 of FIG. 1 may be implemented (e.g., integrated) in the racecar system and provided with a range of temperatures (e.g., temperatures between 175 degrees and 205 degrees Fahrenheit). The system may include a visible light image capture component and a thermal image capture component having a common field of view that includes the front portion of the racecar including the front two tires 205. Visible light and thermal images may be continuously or periodically captured. The images may be stored and/or displayed to the driver or a remote crew member. For example, a racecar may have a display for displaying isothermally enhanced non-thermal images to the driver or may include a communications component for transmitting the isothermally enhanced non-thermal images to a remote display. If no portion of the scene in the field of view is within the range, a purely visible light image from the visible light image capture component may be generated. When the tires (and/or any other portion of the racecar or surrounding scene) heat up to temperature in the provided range, the pixels in the visible light image that represent the tires (and/or the other portions) may be replaced by pixel values from the thermal image that represent the temperature of the tires. In this way, an isothermally enhanced visible light image such as image 200 may be generated.

As shown in FIG. 2, thermal image portions 206 may include isothermal image data having various isothermal portions such as portions 208A and 208B, each representing sub-portions of the tire that have a common temperature using a common color. As shown, the tire on the right has portions that are not in the range defined for the isothermal imaging and masking process, but has a higher temperature gradient (represented by colors ranging from red to purple, indicated by corresponding shading in FIG. 2) that the left tire, even though more of the left tire is within the temperature range.

It should be appreciated that the example of FIG. 2 is merely illustrative and that other applications of systems configured to generate isothermally enhanced images may also be provided for various conditions in which the visible light detail of the visible light image is desired in addition to temperature information for objects within the visible light image. For example, in some situations it may be desirable to monitor a crowd of people for signs of sick people having an elevated temperature while maintaining the ability to visually identify the people. In this type of situation, visible light image portions that have sufficient resolution to identify a human face may be used for identification and thermal image portions may be useful to monitor for people with elevated temperatures. By providing a system such as system 100 that provides isothermally enhanced visible light images, temperature monitoring may be performed with minimal disruption of the visible light imaging (e.g., by only providing thermal pixel data in the image when a sick person having a temperature within a predetermined range is detected in the thermal image and only in the portion of the image with the elevated temperature).

In an output image generated using the isothermal imaging and masking operations described herein, if a temperature range corresponding to one or more objects of interest is selected automatically or by the user, only these objects will have thermal image information (e.g., temperature information) in an image viewed by the user. If a relatively warm temperature range is selected, as an example, relatively cold objects will be represented using visible light image pixel values in the output image.

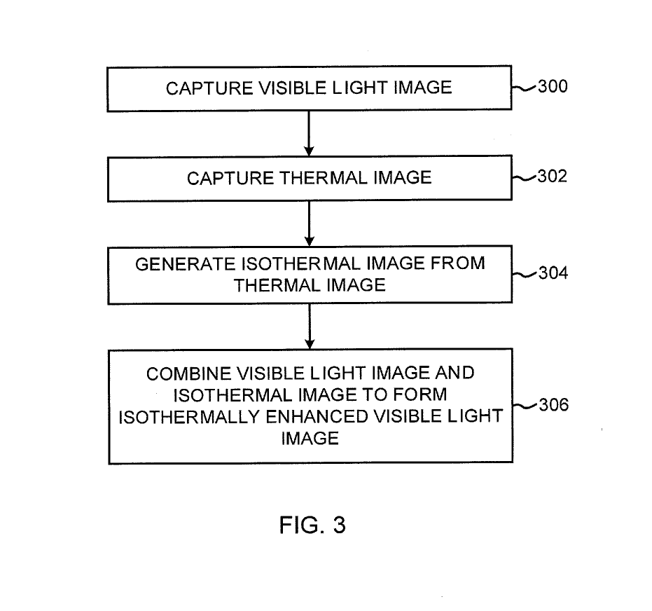

Illustrative operations that may be performed for generating isothermally enhanced visible light images using an isothermal imaging and masking operation are shown in FIG. 3.

At block 300, a non-thermal image such as a visible light image of a scene may be captured (e.g., using non-thermal image capture component 105 of FIG. 1). Various image processing operations such as calibration, scaling, noise reduction, or other processing operations may be performed on the visible light image.

At block 302, a thermal image of at least a portion of the same scene may be captured (e.g., using thermal image capture component 103 of FIG. 1). Various image processing operations may be performed on the thermal image. The image processing operations may include automatic gain control (AGC) operations, smoothing operations, noise reduction operations, non-uniformity correction operations and/or other image processing operations for the thermal images.

At block 304, an isothermal image may be generated from the captured thermal image.

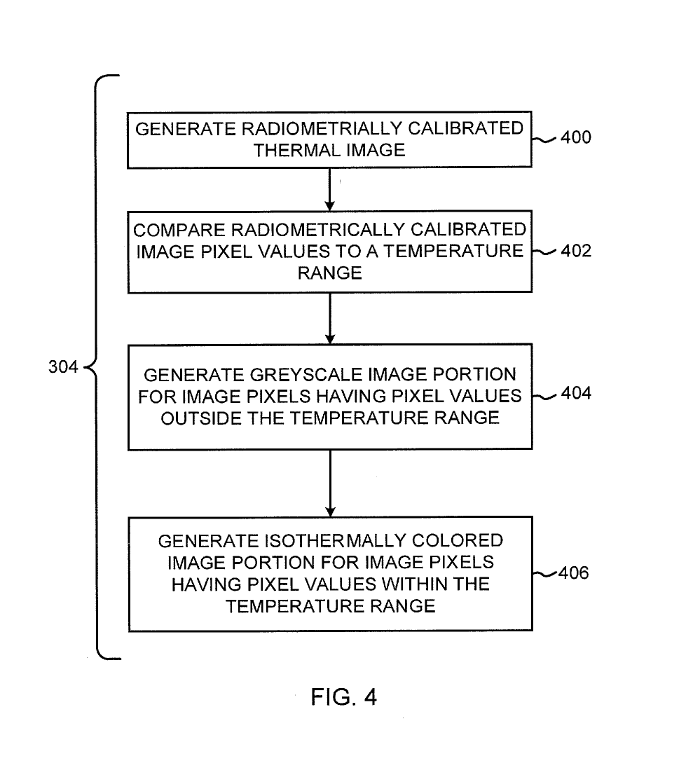

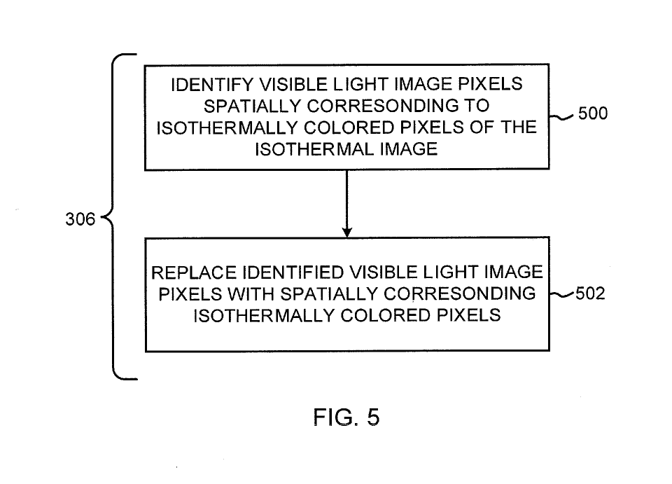

At block 306, the visible light image and the isothermal image may be combined to form the isothermally enhanced image. Further details of the operations that may be performed for blocks 304 and 306 are provided respectively in FIGS. 4 and 5.

Illustrative operations that may be performed for generating an isothermal image from a thermal image as discussed above in connection with block 304 are shown in FIG. 4.

At block 400, a radiometrically calibrated image may be generated from the thermal image. The radiometrically calibrated image may have pixel values that each correspond to a calibrated temperate of the portion of the scene imaged by that pixel. The radiometrically calibrated image pixel values may be determined from the pixel values of the captured thermal image.

At block 402, the radiometrically calibrated image pixel values may be compared to one or more temperature ranges (e.g., a predefined or stored temperature range or a user selected temperature range).

At block 404, a greyscale image portion of an isothermal image may be generated for radiometrically calibrated image pixel values that are outside of the temperature range. The greyscale image portion may include thermal image pixels such as radiometrically calibrated pixels represented in greyscale to indicate the temperature or thermal intensity of the objects imaged by those pixels.

A block 406, an isothermally colored image portion of the isothermal image may be generated for radiometrically calibrated image pixels within the temperature range. The isothermally colored portion may include binned pixel values represented by color values each used for all of the pixels within a particular pixel value bin. The pixel value bins may be bins for pixels within corresponding sub-ranges of the temperature range. In some embodiments, an isothermal mask image may also be generated having masked pixel values corresponding to the greyscale portion and unmasked pixel values corresponding to the isothermally colored portion.

Illustrative operations that may be performed for combining a visible light image and an isothermal image as discussed above in connection with block 306 are shown in FIG. 5.

At block 500, visible light image pixels that spatially correspond to the isothermally colored pixels of the isothermal image may be identified. The corresponding visible light image pixels may be identified based on the isothermal image pixel values themselves or based on further corresponding isothermal mask image pixels having unmasked pixel values. In various embodiments, the resolution of the thermal image and/or the isothermal image may be increased or the resolution of the visible light image may be decreased so that each pixel of the visible light image spatially corresponds to a single pixel of the thermal and/or isothermal image.

At block 502, the values of the identified visible light image pixels may be replaced with the values of the spatially corresponding isothermally colored pixels to form the isothermally enhanced image. In one embodiment, replacing the visible light image pixels may include determining, for each pixel in the image, if a corresponding mask pixel has an unmasked pixel value and replacing the pixel value if the corresponding mask pixel has an unmasked pixel value. In another embodiment, replacing the visible light image pixels may include determining, for each pixel in the image, if a corresponding isothermal image pixel has a color pixel value and replacing the visible light image pixel value if the corresponding isothermal image pixel has a color pixel value.

Where applicable, various embodiments of the invention may be implemented using hardware, software, or various combinations of hardware and software. Where applicable, various hardware components and/or software components set forth herein may be combined into composite components comprising software, hardware, and/or both without departing from the scope and functionality of the invention. Where applicable, various hardware components and/or software components set forth herein may be separated into subcomponents having software, hardware, and/or both without departing from the scope and functionality of the invention. Where applicable, it is contemplated that software components may be implemented as hardware components and vice-versa.

Software, in accordance with the invention, such as program code and/or data, may be stored on one or more computer readable mediums. It is also contemplated that software identified herein may be implemented using one or more general purpose or specific purpose computers and/or computer systems, networked and/or otherwise. Where applicable, ordering of various steps described herein may be changed, combined into composite steps, and/or separated into sub-steps to provide features described herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An imaging system, comprising:
a thermal imaging component configured to capture a thermal image;
a non-thermal imaging component configured to capture a non-thermal image;
a memory that stores at least one temperature range, the at least one temperature range being a specific temperature range narrower than that detectable by the thermal imaging component; and
processing circuitry configured to:
generate an isothermal image based on the thermal image and the at least one temperature range; and
combine the isothermal image with the non-thermal image to form an isothermally enhanced non-thermal image.

2. The imaging system of claim 1, wherein the processing circuitry is configured to generate the isothermal image by generating a color portion of the isothermal image, wherein the color portion of the isothermal image includes image pixels that spatially correspond to image pixels in the thermal image that have temperature values within the at least one temperature range.

3. The imaging system of claim 2, wherein the processing circuitry is further configured to generate the isothermal image by generating a greyscale portion of the isothermal image, wherein the greyscale portion of the isothermal image includes image pixels that spatially correspond to image pixels in the thermal image that have temperature values outside the at least one temperature range.

4. The imaging system of claim 3, wherein the non-thermal image comprises a visible light image and wherein the processing circuitry is configured to generate the isothermally enhanced non-thermal image by combining the color portion of the isothermal image with the visible light image.

5. The imaging system of claim 4, wherein:
the color portion of the isothermal image includes image pixels that each has a color value and spatially corresponds to at least one image pixel of the visible light image; and
the processing circuitry is configured to combine the color portion of the isothermal image with the visible light image by:
generating an isothermal mask image having masked pixel values spatially corresponding to the greyscale portion and unmasked pixel values spatially corresponding to the isothermally colored portion; and
replacing image pixel values of the visible light image that have a spatially corresponding image pixel in the isothermal image with the color value of that image pixel of the isothermal image based on the isothermal mask image.

6. A vehicle comprising the imaging system of claim 4.

7. The vehicle of claim 6, further comprising at least one wheel, wherein the thermal imaging component and the non-thermal imaging component each have a field of view that includes the at least one wheel.

8. The vehicle of claim 7, wherein the vehicle is a racecar.

9. The vehicle of claim 8, further comprising a display configured to display the isothermally enhanced non-thermal image to a driver of the vehicle.

10. A system comprising the vehicle of claim 8 and a remote display, wherein the vehicle comprises a communications component configured to provide the isothermally enhanced non-thermal image to the remote display for display of the isothermally enhanced non-thermal image to a crew member for the racecar.

11. The vehicle of claim 6, wherein the color portion of the isothermal image includes image pixels having a plurality of isothermal color values that each corresponds to a temperature range that is a sub-range of the at least one temperature range.

12. A method, comprising:
capturing a thermal image;
capturing a non-thermal image;
generating an isothermal image based on the thermal image and at least one temperature range, the at least one temperature range being a specific temperature range narrower than that detectable by the thermal imaging component; and
combining the isothermal image with the non-thermal image to form an isothermally enhanced non-thermal image.

13. The method of claim 12, wherein the generating the isothermal image comprises generating a color portion of the isothermal image, wherein the color portion includes image pixels that spatially correspond to image pixels in the thermal image that have temperature values within the at least one temperature range.

14. The method of claim 13, wherein the generating the isothermal image further comprises generating a greyscale portion of the isothermal image, wherein the greyscale portion includes image pixels that spatially correspond to image pixels in the thermal image that have temperature values outside the at least one temperature range.

15. The method of claim 14, wherein the non-thermal image comprises a visible light image and wherein the combining comprises combining the color portion of the isothermal image with the visible light image.

16. The method of claim 15, wherein the image pixels of the color portion of the isothermal image each has a color value and spatially corresponds to at least one image pixel of the visible light image and wherein the combining the color portion of the isothermal image with the visible light image comprises:
generating an isothermal mask image having masked pixel values spatially corresponding to the greyscale portion and unmasked pixel values spatially corresponding to the isothermally colored portion; and
replacing image pixel values of the visible light image that have a spatially corresponding image pixel in the isothermal image with the color value of that image pixel of the isothermal image based on the isothermal mask image.

17. The method of claim 16, providing the imaging system in a vehicle comprising at least one wheel such that a thermal imaging component for capturing the thermal image and a non-thermal imaging component for capturing the non-thermal image each have a field of view that includes the at least one wheel.

18. The method of claim 17, wherein the vehicle is a racecar and wherein the method further comprises displaying the isothermally enhanced non-thermal image to a driver of the vehicle using a display of the racecar.

19. The method of claim 17, further comprising:
providing the isothermally enhanced non-thermal image to a remote display; and
displaying the isothermally enhanced non-thermal image to a crew member for the racecar with the remote display.

20. The method of claim 13, wherein generating the color portion of the isothermal image comprises:
comparing image pixel values of the thermal image to a plurality of temperature sub-ranges within the at least one temperature range: and
assigning a color value to each image pixel in the color portion based on the comparing.
